(19) United States
(12) Patent Application Publication
(10) Pub. No.: US 2003/0101872 A1
(43) Pub. Date: Jun. 5, 2003

(54) UV inhibitors in HVAC plastic components

(75) Inventors: Christopher E. Peel, Noblesville, IN (US); Kevin H. Waldo, Greenwood, IN (US)

Correspondence Address: WALL MARJAMA & BILINSKI, 101 SOUTH SALINA STREET, SUITE 400, SYRACUSE, NY, 13202, US

(73) Assignee: Carrier Corporation

(21) Appl. No.: 10/007,517

(22) Filed: Dec. 5, 2001

(51) Int. Cl. B01D 46/00

(52) U.S. Cl. 96/224; 422/121; 422/186.3

(57) ABSTRACT

A system which includes a forced air system with interconnected ducting and a humidifier positioned at a predetermined location in the ducting, with the system further includes a source of UV radiation for controlling bacteria. The improvement resides in providing plastic material for all components in the humidifier and other system component parts which contains a UV inhibiting material to combat UV deterioration of the plastic.

### BACKGROUND OF THE INVENTION

The present invention relates in general to heating, ventilation and air conditioning (HVAC) systems and more specifically to preventing the deterioration of plastic components used in these systems which are exposed to UV radiation.

There have been recent concerns regarding the effects of ultra violet light on plastic materials used in conjunction with HVAC systems. Plastic products used with a HVAC system typically do not contain UV inhibitors because the products were never intended to be exposed to sunlight. Sunlight was considered the primary source of UV light. Recently, HVAC contractors have begun installing UV lights in the evaporator coil cabinet and return air ducting of the HVAC system to prevent mold growth on the coil and in the ducting due to bacteria.

Typically a humidifier is installed directly above the evaporator coil compartment. When UV lights are installed in the evaporator coil compartment the UV light will shine on the interior plastic portion of the humidifier and other plastic components such as the humidifier pad molding. Plastic-bodied humidifiers on the market today are not manufactured with plastic containing UV light inhibitors. As a result the plastic can deteriorate with prolonged exposures to UV lights. In some cases the deterioration of the humidifier plastic housing can result in the housing breaking away from ducting and result in serious damage due to water leakage both within and outside of the HVAC system. To combat this problem many manufacturers require that the humidifier be installed at least 3 feet away and in some cases as much as 12 feet away from the UV lights. These restrictions create a hardship for the installer because on most installations there is not adequate space to adhere to these requirements.

It can therefore be seen that there is a need to address and overcome the problem of plastic deterioration due to UV exposure of plastic components in HVAC systems.

### SUMMARY OF THE INVENTION

It is therefore an object of the present invention to provide a system which overcomes UV deterioration of plastics in HVAC systems.

It is a further object of the present invention to provide components for HVAC systems which do not deteriorate when exposed to UV radiation.

It is a further object of the present invention to provide UV inhibiting plastic for components in a HVAC system which are exposed to UV radiation.

These and other objects of the present invention are accomplished by providing plastic components in a HVAC system which includes a UV inhibitor component in systems where UV light is present to control bacteria. More specifically the invention is directed to providing plastics containing UV inhibitors for all plastic materials including humidifier components and housings, filtration devices, media cabinets and any other components which are exposed to UV radiation.

### BRIEF DESCRIPTION OF THE DRAWING

For a further understanding of these and objects of the invention, reference will be made to the following detailed description of the invention which is to be read in connection with the accompanying drawing, wherein:

FIG. 1 is a perspective partial view of a forced air furnace system which illustrates the present invention.

### DETAILED DESCRIPTION OF THE INVENTION

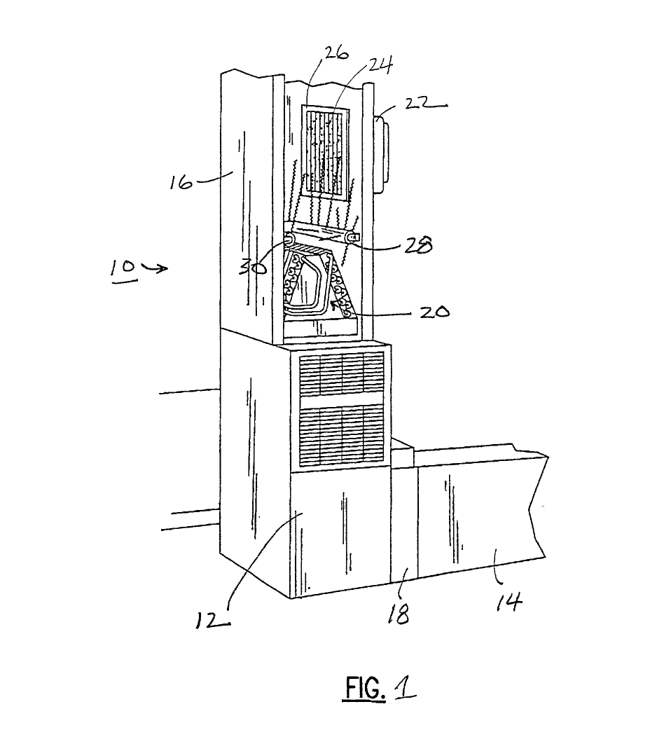

As illustrated in FIG. 1, a forced air furnace system 10 is depicted and comprises in combination a conventional forced air furnace 12 (details not shown) connecting ducting 14 and 16, air cleaner cabinet 18, evaporator coil assembly 20, humidifier 22 containing a humidifier pad 24 and surrounding plastic molding 26. A pair of longitudinal UV radiation lights 28 and 30 are disposed within the evaporator coil compartment to control bacteria. In operation, the UV radiation will contact the interior of the plastic portions of the humidifier and other component parts and as a result, the plastic, which contains an UV inhibitor will not deteriorate with prolonged exposure to UV light.

Suitable plastics and inhibitors which can be used in the present invention are:

1. IDI #44-10 (10% glass filled polyester) with less than 1% Tinuvin-P for UV stabilization.

2. GE C2951 ABS/PC material with less than 1% Penzo Traiazol for UV stabilization.

These plastics are commercially available from IDI Co and GE.

It should be understood that any suitable plastic containing a UV inhibitor may be used in the present invention.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. In a heating, ventilation and air conditioning system which includes a forced air furnace with interconnected ducting and a humidifier located in a predetermined position, with said humidifier and related components containing various plastic parts, said system further including a source of UV radiation for controlling bacteria, the improvement comprising providing a UV inhibiting plastic material for all UV exposed plastic parts and components.

2. In a system which includes a forced air furnace with interconnected ducting and a humidifier located in a predetermined position, said system further including a source of UV radiation for controlling bacteria, the improvement comprising providing a UV inhibiting plastic material for all components in said humidifier and supporting component parts to combat UV deterioration.

3. In a HVAC system which includes interconnected ducting and various plastic components in said system, including but not limited to humidifiers, filtrations devices, media cabinets and molding for components, and where said system includes at least one source of UV radiation for controlling bacteria, providing UV inhibiting plastic material for all plastic parts and components which are exposed to UV radiation.
